(19) United States
(12) Patent Application Publication
(10) Pub. No.: US 2025/0225430 A1
(43) Pub. Date: Jul. 10, 2025

(54) AI-BASED VISUAL STYLE TRANSFER

(71) Applicant: Microsoft Technology Licensing, LLC, Redmond, WA (US)

(72) Inventors: Mingxi CHENG, Los Angeles, CA (US); Ji LI, San Jose, CA (US)

(73) Assignee: Microsoft Technology Licensing, LLC, Redmond, WA (US)

(21) Appl. No.: 18/406,739

(22) Filed: Jan. 8, 2024

(51) Int. Cl. G06N 20/00; G06F 9/451

(52) U.S. Cl. CPC G06N 20/00; G06F 9/451

(57) ABSTRACT

A data processing system implements receiving a first prompt including a style visual content item and a topic content item and requesting generating an output visual content item; constructing a second prompt as an input to a first generative model, by appending the style visual content item and the topic content item to a first instruction string that comprises instructions to the first generative model to generate a textual description combining a topic in the topic content item with a style in the style visual content item as a third prompt; inputting the third prompt into a second generative model to generate the output visual content item by including the topic in the output visual content item and replacing visual element(s) of the style visual content item based on the topic while preserving the style; and providing the output visual content item to be presented on a user interface.

### BACKGROUND

Artificial intelligence (AI) has the potential to automate our lives to save time and increase productivity. One area of interest is visual content creation, and image generative models have become popular and powerful tools for creating visual content. However, the existing AI-based image generation platforms or applications require users to craft creative images based on a text-to-image approach. It is frustrating and/or time-consuming for the users to repeatedly tweak the text prompts to generate images before getting satisfactory results, even when starting from an existing text prompt template. There are technical challenges to provide users with easier AI-based visual content creation to utilize existing images and designs made by professional designers, other users, and/or AI. Hence, there is a need for easy-to-use AI-based visual content creation systems and methods.

### SUMMARY

An example data processing system according to the disclosure includes a processor and a machine-readable medium storing executable instructions. The instructions when executed cause the processor alone or in combination with other processors to perform operations including receiving, via a user interface of a client device, a first prompt requesting an output visual content item to be generated, the first prompt including a style visual content item and a topic content item; constructing a second prompt by a prompt construction unit as an input to a first generative model, by appending the style visual content item and the topic content item to a first instruction string, the first instruction string comprising instructions to the first generative model to generate a textual description combining a topic in the topic content item with a style in the style visual content item as a third prompt; inputting the third prompt into a second generative model to generate the output visual content item by including the topic in the output visual content item and replacing one or more visual elements of the style visual content item based on the topic while preserving the style; providing the output visual content item to the client device; and causing the user interface to present the output visual content item.

An example method implemented in a data processing system includes receiving, via a user interface of a client device, a first prompt requesting an output visual content item to be generated, the first prompt including a style visual content item and a topic content item; constructing a second prompt by a prompt construction unit as an input to a first generative model, by appending the style visual content item and the topic content item to a first instruction string, the first instruction string comprising instructions to the first generative model to generate a textual description combining a topic in the topic content item with a style in the style visual content item as a third prompt; inputting the third prompt into a second generative model to generate the output visual content item by including the topic in the output visual content item and replacing one or more visual elements of the style visual content item based on the topic while preserving the style; providing the output visual content item to the client device; and causing the user interface to present the output visual content item.

An example data processing system according to the disclosure includes a processor and a machine-readable medium storing executable instructions. The instructions when executed cause the processor alone or in combination with other processors to perform operations including receiving, via a user interface of a client device, a first prompt requesting an output visual content item to be generated, the first prompt including a style visual content item and a topic content item; constructing a second prompt by a prompt construction unit as an input to a first generative model, by appending the style visual content item and the topic content item to a first instruction string, the first instruction string comprising instructions to the first generative model to generate a textual description combining a topic in the topic content item with a style in the style visual content item as a third prompt; inputting the third prompt into a second generative model to generate the output visual content item by including the topic in the output visual content item and replacing one or more visual elements of the style visual content item based on the topic while preserving the style; providing the output visual content item to the client device; and causing the user interface to present the output visual content item.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram of an example computing environment in which the techniques for AI-based visual style transfer via automatically describing a visual content item in a text prompt are implemented.

FIGS. 1B-1C are conceptual diagrams of a visual style transfer pipeline of the system of FIG. 1A according to principles described herein.

FIGS. 2A-2I are diagrams of example user interfaces of an AI-based visual style transfer application that implements the techniques described herein.

FIG. 3 is a diagram showing additional features of a prompt construction unit of the application services platform shown in FIG. 1A.

FIG. 4 is a flow chart of an example process for AI-based visual style transfer via automatically describing a visual content item in a text prompt according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for AI-based visual style transfer via automatically describing a visual content item in a text prompt are described herein. These techniques provide a technical solution to the technical problem of lack of easy-to-use AI-based visual content generation platforms/systems. The existing AI-based visual content generation systems automate many design tasks that were previously done manually, such as image generation, text layout, color selection, and the like. Prompt engineering has been a critical aspect of Large Language Models (LLMs) and Large Vision Models (LVMs) since their inception. Effective prompting skills are essential for achieving high-quality visual content outputs when utilizing LVMs.

Although these systems help users to work more efficiently and produce more visual content, they often require the users to repeatedly tweak the text prompts to generate satisfactory images. This is because the models are trained on large datasets of images to generate images that are statistically similar to the images in the dataset. While this does lead to generating images consistent with the user's text inputs, users often have to adjust the text inputs to get satisfactory images. Even when starting with a pre-existing text prompt, the user still needs to make subtle adjustments to the text to tailor the output to the user's specific requirements. While this text-to-image approach can provide impressive results, its efficacy is contingent upon the user's proficiency in crafting effective text prompts.

To address these issues, the proposed technical solution improves visual content generation using generative model(s) by providing users with AI-based visual style transfers via automatically describing a visual content item in a text prompt and inputting the text prompt into a vision generative model. The system provides a novel visual style transfer pipeline designed to streamline the user experience. This pipeline eliminates the need for manually converting an image into a text prompt. Rather, the pipeline enables users to directly upload an image as a style prompt. The pipeline then autonomously executes the remaining processes of image generation and style transfer behind the scenes. This pipeline not only simplifies the workflow but also enhances the accessibility and efficiency of style replication in image creation.

By applying generative model(s) on a style visual content item (e.g., an image) and a topic content item (e.g., an image/text content item) selected by the user, the system/pipeline can replace visual elements of the style visual content item based on a topic in the topic content item. As such, the user can easily generate desired visual content item(s) that are consistent with the selected style and topic. The system thus preserves the style of the visual content item (e.g., the layout and structure, color, style, typography, whitespace, texture, scale, or the like) and changes the visual elements of the visual content item to match the topic.

In one example, the system provides an improved method for image style transfer that allows the user to upload an image as a style prompt thereby creating higher quality, stylized images, without manually crafting complex text prompts that are difficult for non-experts. In one embodiment, the system provides a pipeline architecture for creating images based on style transfer using a combination of a large language model (LLM, e.g., GPT-4V) and a large visual model (LVM, e.g., DALLE-3), which can be collectively a large multimodal model (LMM). For example, the pipeline takes a user style request (e.g., a style image) and a user content request (e.g., a topic content item, such as a topic text/image) as input, to generate a textual prompt describing the user-requested style infused with the topic therein using the LMM, and then create an output image using the textual prompt. Therefore, the system provides an easy-to-use user experience (UX) related to a style image in which a tangible result in the form of a stylized image infused with a desired topic are produced responsive to the user style and content requests.

A technical benefit of the approach provided herein is to perform visual content style transfer through LMMs and LVMs within a design platform with great user convenience by allowing users to upload an image as a style prompt, thereby alleviating the burden of style text prompt engineering during the image creation process.

Another technical benefit of this approach is to provide a visual style transfer pipeline that takes an existing style and a user selected topic at runtime to produce an output image with the transferred style and topic to present to the user. The automated visual content style transfer can offer more user choices than one simple output, thereby improving the user experience. Moreover, the output image(s) in the form of the selected style and topic is presented to the user with high quality.

Another technical benefit of the approach provided herein is to capitalize on a suite of powerful tools to understand user style requests and content requests, both of which can be in image and/or text format. By converting the image style prompt into a text style prompt, the system generates and refines the image style prompt with the user-requested topic infused, and creates the image output based on the requested style and topic. Therefore, the generated image output(s) more accurately represents the user preferences. Not only does this improve the productivity of the user, but this approach can also decrease the computing resources required to refine the visual content items based on refined user queries to the generative models.

Another technical benefit of the approach provided herein is to support visual content style transfer not only for pure visual content items but also for visual content items with text, thereby increasing the diversity of image generation as well as applications in many downstream tasks, such as design template creation.

Another technical benefit of the approach provided herein is to significantly improve the user experience in image creation within a design platform and in deployment as a new mini-application within the design platform.

Another technical benefit of this approach is storing the image output(s) as style image(s) in the system thereby saving the user significant time and effort in creating similar visual content in the future. Yet another technical benefit of this approach is that other users can utilize the new style image(s) to save time and effort. These and other technical benefits of the techniques disclosed herein will be evident from the discussion of the example implementations that follow.

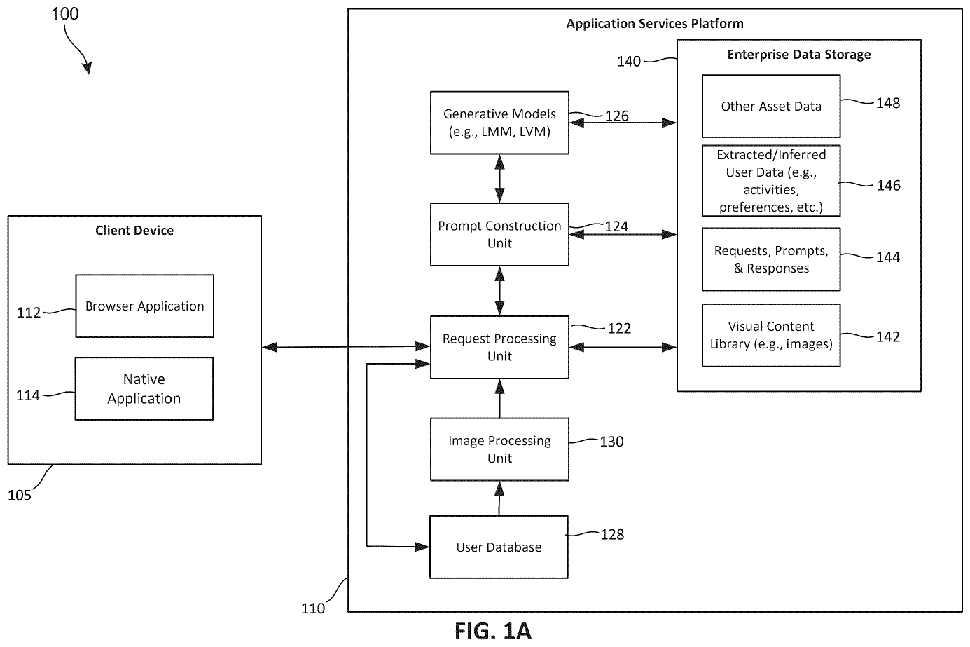

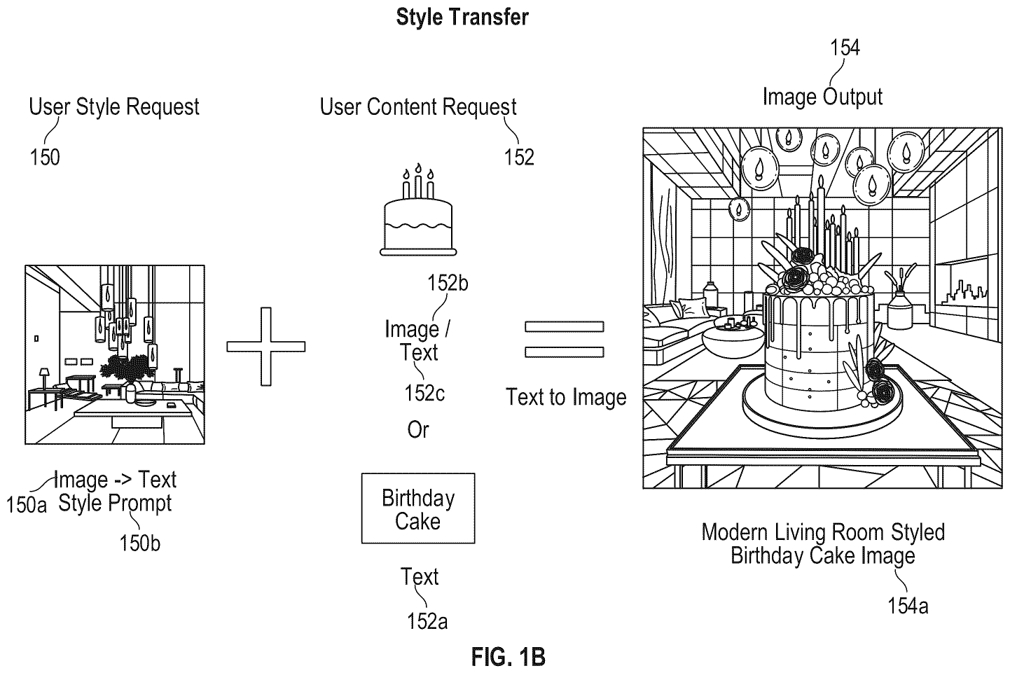

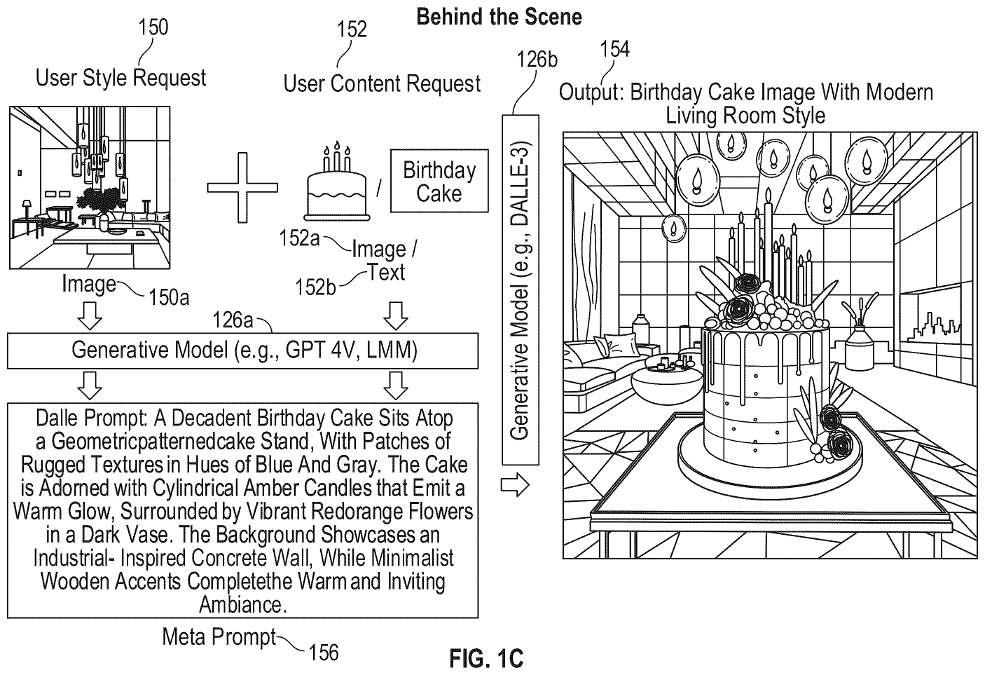

FIG. 1A is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to AI-based visual content creation applications, presentation applications, website authoring applications, collaboration platforms, communications platforms, and/or other types of applications in which users may create, view, and/or modify various types of graphic designs. In the implementation shown in FIG. 1A, the application services platform 110 also applies generative AI to easily generate fast and satisfactory visual content outputs upon user demand according to the techniques described herein. The client device 105 and the application services platform 110 communicate with each other over a network (not shown). The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1A includes a single client device 105, other implementations may include a different number of client devices that utilize services provided by the application services platform 110.

Style transfer is a technique in computer vision and graphics that involves generating a new visual content item (e.g., an image) by combining the content of one image with the style of another image. In the context of style transfer, style refers to the distinctive visual characteristics of a visual content item (e.g., an image). These characteristics can include color palette, texture (e.g., brushstrokes), composition, layout, level of details and abstraction, overall mood, atmosphere, and the like.

The term “visual content item” refers to any human visible content item. Common forms of visual content items include photos, diagrams, charts, images, infographics, videos, animations, screenshots, memes, slide decks, pictograms, ideograms, gaming interfaces, software application backgrounds, graphic designs (e.g., publication, email marketing templates, PowerPoint presentations, menus, social media ads, banners and graphics, marketing and advertising, packaging, visual identity, art and illustration graphic design, and the like), etc.

“Textual prompt” and “text prompt” are used interchangeably in the disclosure. “Textual prompt” is more formal, while “text prompt” is more casual.

As used herein, the term “topic” in the context of content items refers to any content subject matter desired by a user and described in a content item, such as text, image, video, and the like.

Although various embodiments are described with respect to image style transfer based on one style image and one content topic, it is contemplated that the approach described herein may be used to generate one image output based on a plurality of style images and/or a plurality of content topics.

Although various embodiments are described with respect to image style transfer, it is contemplated that the approach described herein may be used with any visual content style transfer, such as graphic designs (e.g., publication, email marketing templates, PowerPoint presentations, menus, social media ads, banners and graphics, marketing and advertising, packaging, visual identity, art and illustration graphic design, and the like), photography, videography, animation, motion graphics, user interface graphic design (e.g., game interface, app design, etc.), event and conference spaces, and the like.

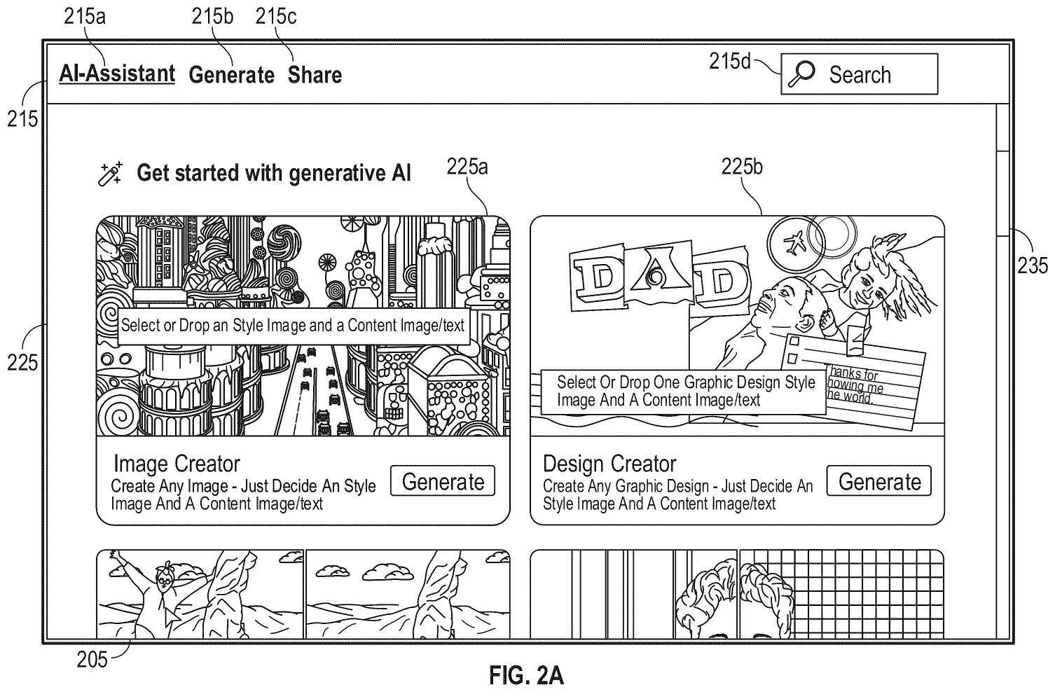

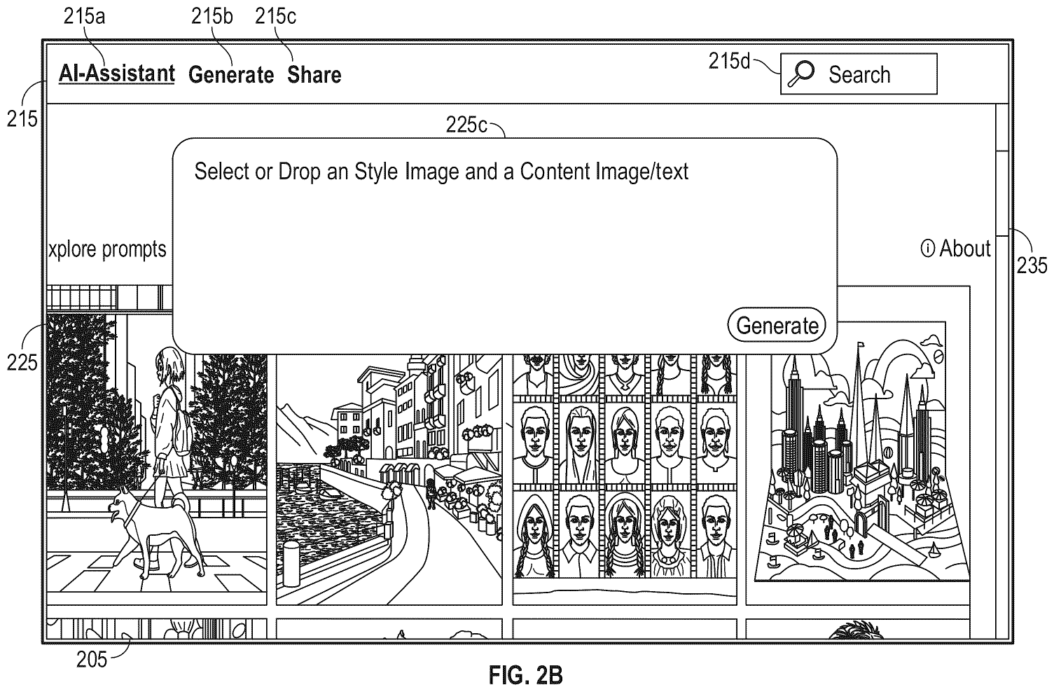

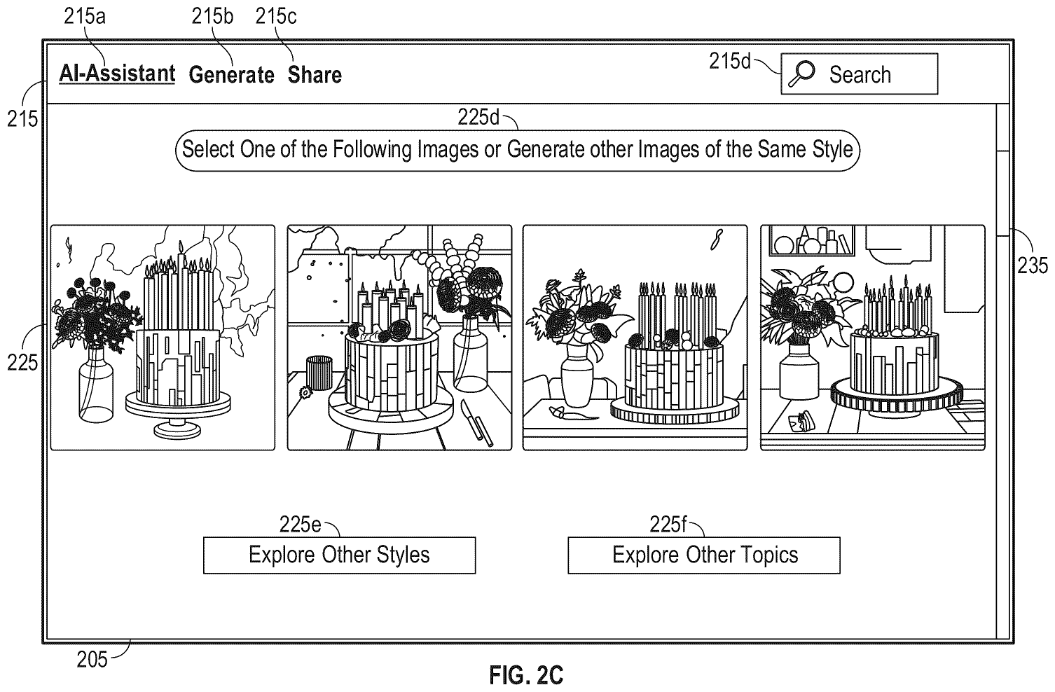

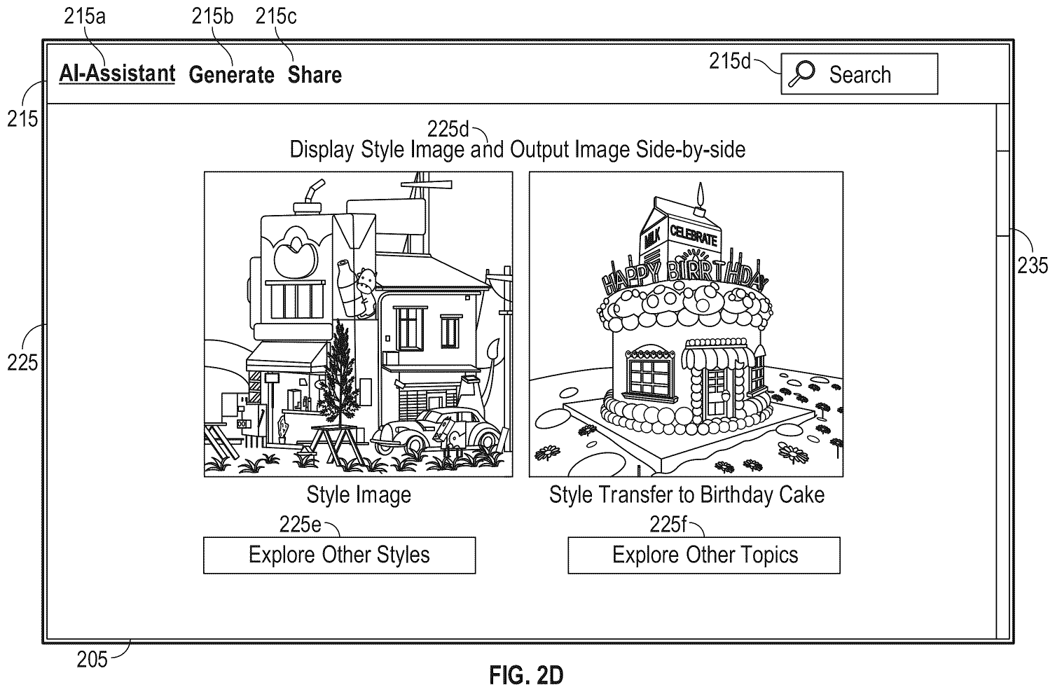

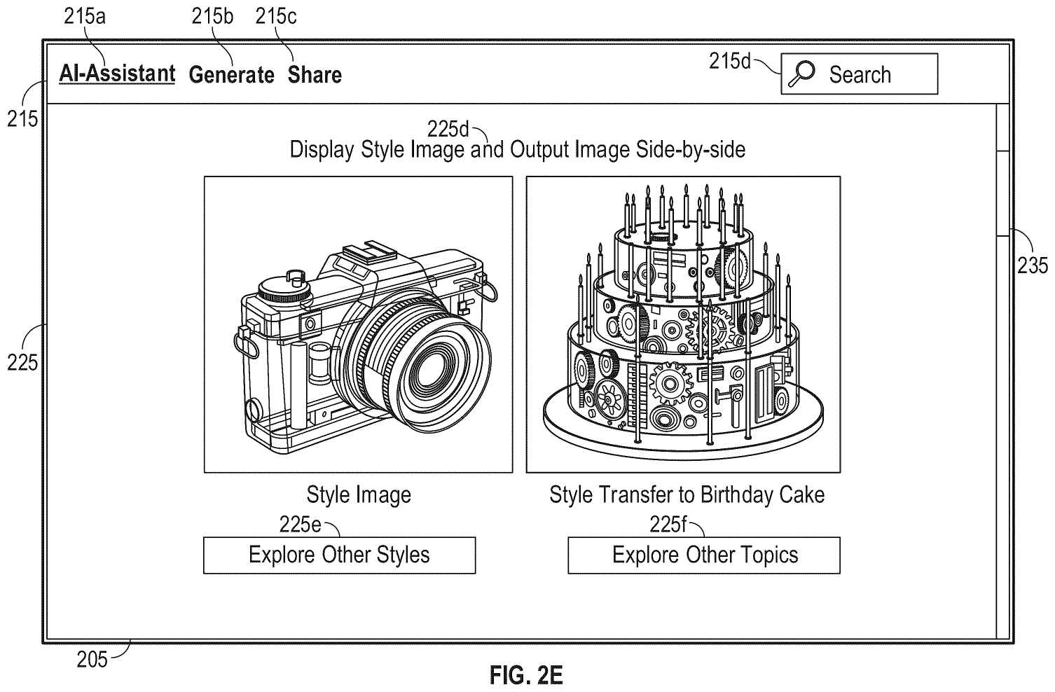

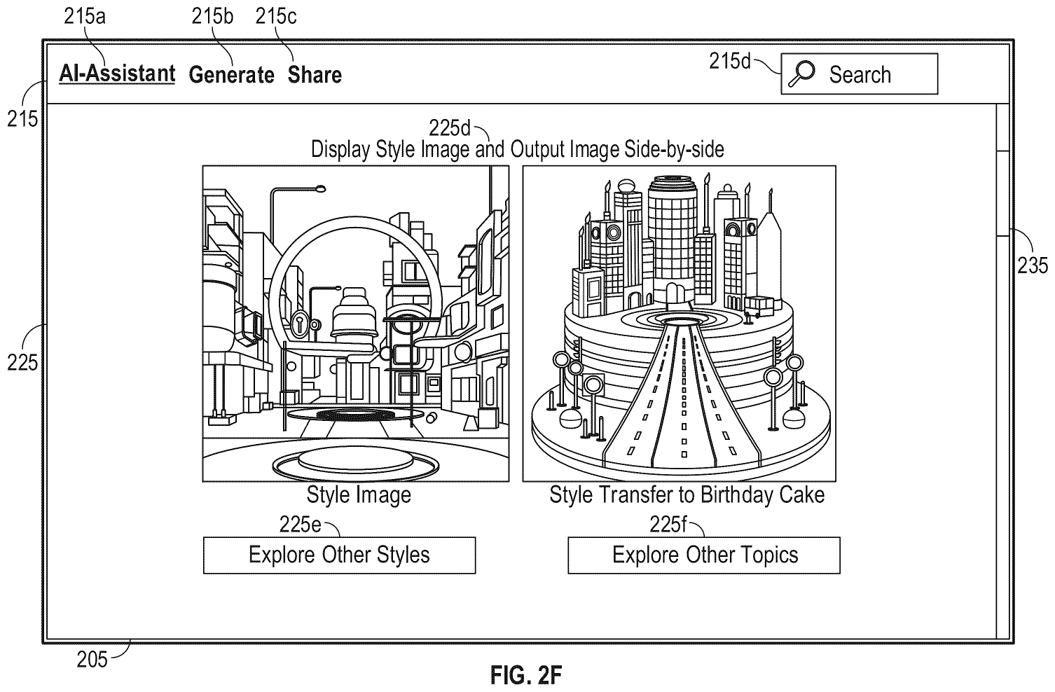

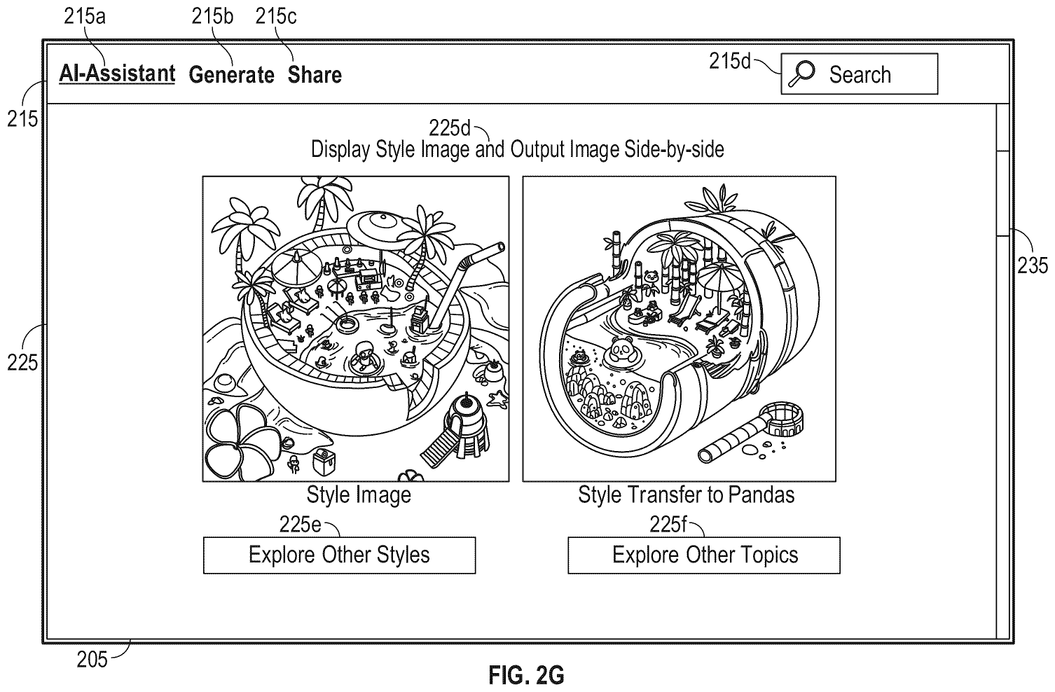

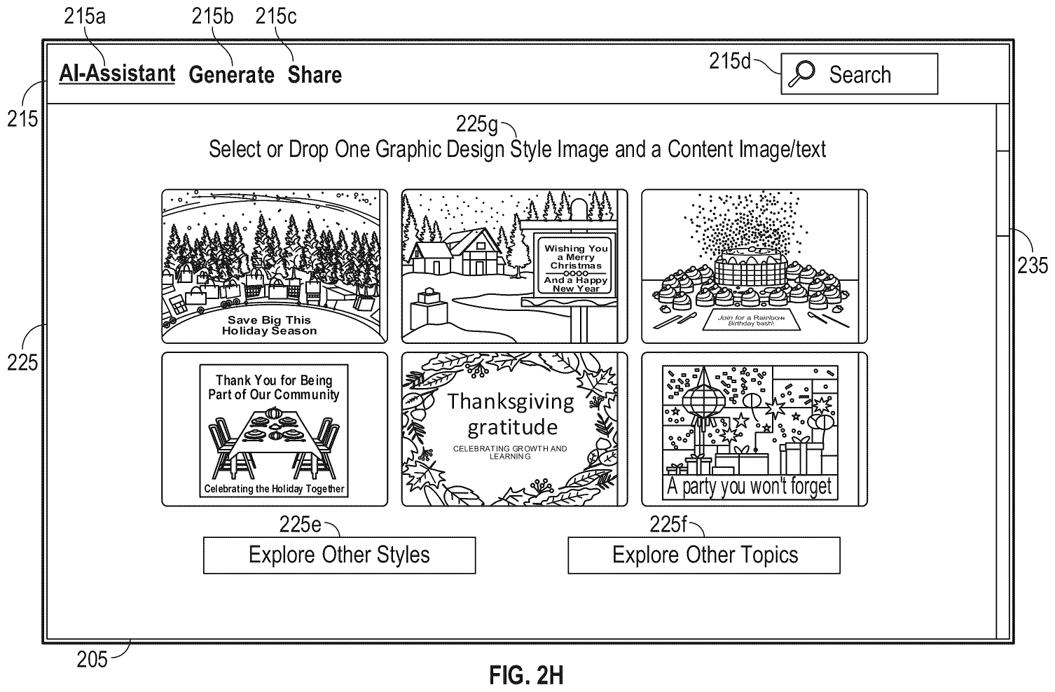

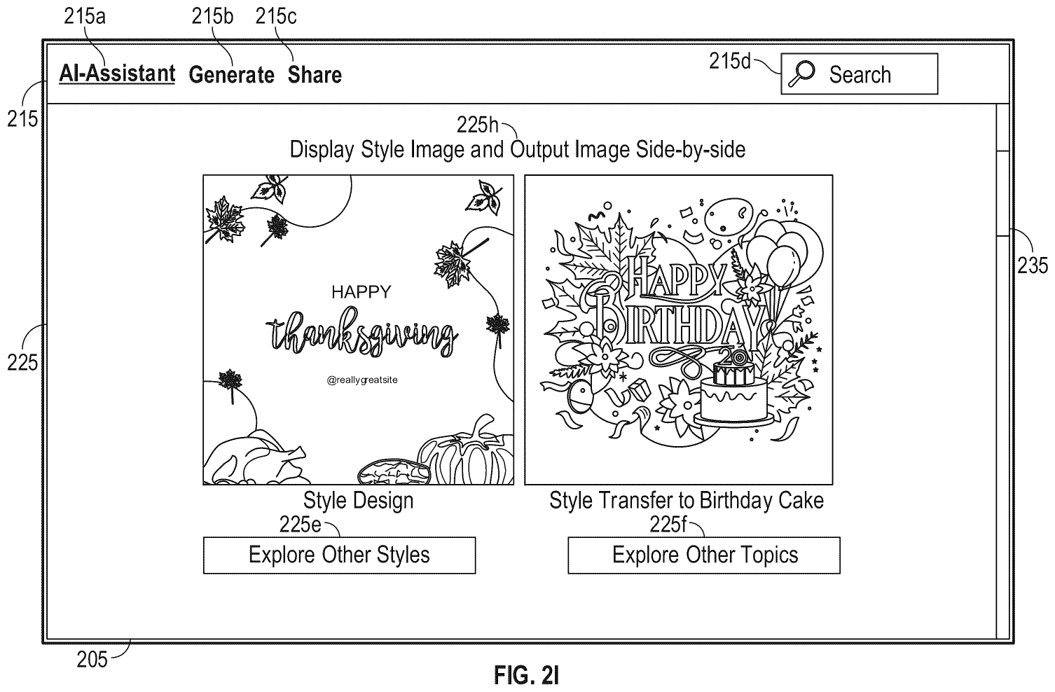

The client device 105 includes a native application 114 and a browser application 112. The native application 114 is a web-enabled native application, in some implementations, which enables easy visual content style transfer. The web-enabled native application utilizes services provided by the application services platform 110 including but not limited to creating, viewing, and/or modifying various types of visual content style transfer. The native application 114 implements a user interface 205 shown in FIGS. 2A-2I in some implementations. In other implementations, the browser application 112 is used for accessing and viewing web-based content provided by the application services platform 110. In such implementations, the application services platform 110 utilizes one or more web applications, such as the browser application 112, that enables users to view, create, and/or modify visual content style transfer using for example an online application. The browser application 112 implements the user interface 205 shown in FIGS. 2A-2I in some implementations. The application services platform 110 supports both the native application 114 and the browser application 112 in some implementations, and the users may choose which approach best suits their needs.

The application services platform 110 includes a request processing unit 122, a prompt construction unit 124, generative model(s) 126, a user database 128, an image processing unit 130, an enterprise data storage 140, and moderation services (not shown).

The request processing unit 122 is configured to receive requests from the native application 114 and/or the browser application 112 of the client device 105. The requests may include but are not limited to requests to create, view, and/or modify various types of visual content items and/or sending prompts to generative model(s) 126 (e.g., an image generative model) to generate visual content items according to the techniques provided herein.

FIGS. 1B-1C are conceptual diagrams of a visual style transfer pipeline of the system of FIG. 1A according to principles described herein. The pipeline leverages the advanced capabilities of LLMs and LVMs in the visual style transfer pipeline. This pipeline is designed to generate images based on user-requested styles, e.g., utilizing images as prompts instead of text. In one embodiment, the generative models 126 includes a first generative model 126a that automatically describes a visual style selected by a user in a text prompt and a second generative model 126b that inputs the text prompt to generate visual content item(s). With an extracted text style prompt and the user's content request, the system can combine the two through another LLM call to produce a valid LVM prompt. This integrated text prompt adheres to the user's requested style and includes the user-requested topic content.

The first generative model 126a (e.g., an LLM, LMM, or the like) can interpret and convert style elements of a user style image by generating a style text prompt. Either prompt construction unit 124, or the first or second generative model can integrate the style text prompt with a topic extracted from a user content request into an integrated text prompt. This user content request may be presented in either text or image format. The second generative model 126b (e.g., a LVM, text-to-image model, or the like) can process the integrated text prompt to generate visual content item(s) that embodies both the user's style and topic preferences. In the following example, the user requests a birthday cake in the style of a modern living room, using an image of a modern living room as a style request and a text or image of a birthday cake as a content request.

In FIG. 1B, the request processing unit 122 receives a user style request 150 (including a style image/prompt 150a), and forwards it to the first generative model 126a (e.g., GPT-4V) to converts the style image/prompt 150a (e.g., a modern living room image) into a style text prompt 150b. To understand the image style, the system prompts the first generative model 126a endpoint to interpret the image, describe it, and then convert the image description into an LVM prompt. In one embodiment, the system provides detailed guidance with a meta prompt as shown in Table 1. The meta prompt in Table 1 provides context and guidance to the first generative model 126a, and helps the model capture the style in the style image/prompt 150a. As such, the first generative model 126a produces an accurate a text prompt capable of reproducing the style image/prompt 150a, forming the basis for style transfer onto the topic (e.g., a birthday cake). The meta prompt can be adapted or extended based on different implementations, such as different generative models.

TABLE 1
Your task is to copy the style of an AI-generated image and recreate a compelling DALL•E
prompt. As a bot, your role is to understand the provided image and craft a DALL•E
prompt that captures the style and colors of the image and apply it to a new topic. In
addition, make sure to capture the details and style of the image, proportions and
perspective, color palette, lighting and shadows, texture and material, mood and
atmosphere, context and background of the image. Could you generate a DALLE image
prompt for a {user requested object} with the same style and colors as shown in the sample
image?

The request processing unit 122 also receives a user content request 152 (including a topic such as a birthday cake). When the topic textual content is a topic textual content 152a, the request processing unit 122 forwards the topic textual content 152a to the prompt construction unit 124 or the first generative model 126a to be directly integrated with the style text prompt 150b into an integrated text prompt (e.g., a meta prompt 156 in FIG. 1C and Table 2). The meta prompt in Table 2 provides style and topic context and guidance to the second generative model 126b, to improve the quality and consistency of the image output 154.

TABLE 2
A decadent birthday cake sits atop a geometric-patterned cake stand, with patches of
rugged textures in hues of blue and gray. The cake is adorned with cylindrical amber
candles that emit a warm glow, surrounded by vibrant red-orange flowers in a dark vase.
The background showcases an industrial-inspired concrete wall, while minimalist wooden
accents complete the warm and inviting ambiance.

When the topic is a topic visual content 152b (e.g., a birthday cake image), the request processing unit 122 forwards the topic visual content 152b to the first generative model 126a to be converted into a topic textual prompt 152c. The prompt construction unit 124 or the first generative model 126a can then integrate the topic textual prompt 152c with the style text prompt 150b into an integrated text prompt. The second generative model 126b (e.g., DALLE-3) can process the integrated text prompt to generate an image output 154, e.g., a modern living room styled birthday cake image 154a.

In another embodiment, the meta prompt in Table 2 also includes a negative prompt to steer the second generative model 126b away from generating text. A negative prompt is the opposite of a positive prompt, which is used to guide the model towards generating the specific type of content. In other embodiments, the meta prompt can include a negative prompt to avoid generating a “blurry,” “pixelated,” “low quality,” “violent,” or “hateful” image.

In another embodiment, the system further provides prompt refinement. Once we have the integrated text prompt, the system undertakes an optional prompt refinement step through another generative model call, such as calling the first generative model 126a based on a feedback loop (e.g., a reflection loop). In some implementations, each generative model call needs to pass a responsible AI test. In one embodiment, a responsible AI test is a comprehensive evaluation process that ensures a generative model adheres to ethical principles and operates safely and fairly in the real world. In another embodiment, the test not only checks if the generative model performs its intended task accurately, but also assess its potential for harm and mitigating negative impacts.

For instance, the meta prompt in Table 1 and/or the meta prompt 156 in Table 2 can be a self-improving agent that can modify its own instructions based on its reflections on user interactions. In one embodiment, the meta prompt 156 can include instructions that guides the agent on how to improve its own instructions based on user positive, neutral, or negative feedback on the image output 154, such as a user selection of a thumbs-up tab, a thumbs-down tab, a neutral tab, or a generating-more-image tab, a textual input, or the like. The system can then create another image output based on the refined integrated text prompt, and serve the refined image output to the user.

In yet another embodiment, the system further improves the quality of the image output 154 via a quality check to ensure that the integrated text prompt contains the requested style and topic. The system can then create the image output based on the checked integrated text prompt, and serve the image output to the user.

In some implementations, instead of image style transfer based on one style image and one content topic as the above-discussed example, the system can generate one image output based on a plurality of style images (e.g., a gaming console image, a checkout machine image, a typewriter image, and an ice cream machine image) and/or a plurality of content topics (e.g., a birthday cake and a birthday party).

In other implementations, instead of image style transfer based on one style image and one content topic as the above-discussed example, the system can generate other visual content output (e.g., photos, diagrams, charts, images, infographics, videos, animations, screenshots, memes, slide decks, pictograms, ideograms, gaming interfaces, software application backgrounds, graphic designs, or the like) based on the style image and the content topic. For example, the system can generate a birthday party card based on a holiday greeting card and a birthday cake image.

In some implementations, the system makes the image output 154 produced by the pipeline editable, such as adding textual content in the image output 154, thus offering more user control over their AI-generated content (AIGC) experiences. For instance, after setting up the particular style, either the first generative model 126a or the prompt construction unit 124 can preformulate meta-prompt(s) for querying the user for more birthday party details, such as the birthday date, party address, RSVP deadline, and the like, and then adding the details to the image output 154.

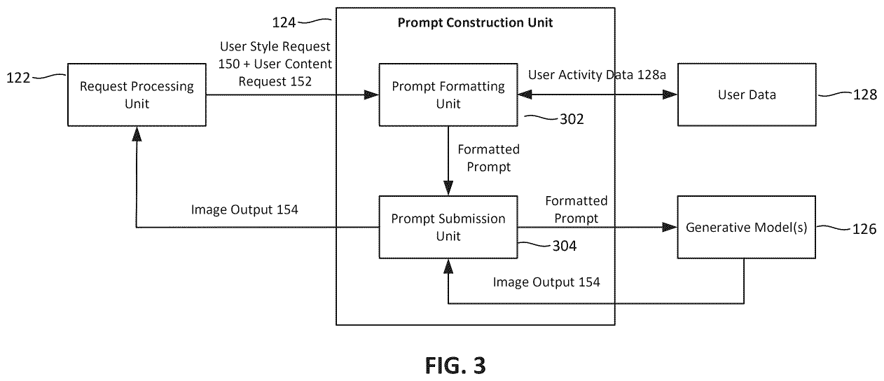

In another embodiment, the prompt construction unit 124 can use user data from various user data source(s) to generate the birthday party details for generating the birthday party card. For instance, user activity data 128a (depicted in FIG. 3) can be digitized and stored in the user database 128. The user data source(s) can be online/offline databases (e.g., emails, social media posts, and the like), documents, articles, books, presentation content, and/or other types of content containing user activity information.

In one embodiment, in response to the user prompt, the prompt construction unit 124 can retrieve user activity data 128a (shown in FIG. 3) from the user database 128 based on an indication identifying the user. The indication may be a user identifier (e.g., a username, email address, and the like), and/or other identifier associated with the user that the application services platform 110 can use to identify the user and retrieve user data. The user data can include a username, a user organization, a user preferred graphic design style (e.g., minimalism, retro, art deco, Memphis design, Swiss style, Bauhaus, pop art, punk, etc.), and the like. As such, when the user does not provide the required information to generate the birthday party invitation, the prompt construction unit 124 may retrieve the missing information from the user activity data 128a, instead of asking more questions for the missing information via an AI chat interface.

The first generative model 126a can be any language generative model trained to generate textual content describing visual prompts with details/nuances and accuracy. For instance, the first generative model 126a may be GPT-4V, Imagen, Contrastive Language-Image Pretraining (CLIP), Flamingo, Perceiver, Multitask Unified Model (MUM), or the like.

The second generative model 126b can be any visual generative model trained to generate visual content (e.g., image, video, and the like) blending topic(s) and style(s) seamlessly in response to natural language prompts. For instance, the second generative model 126b may be CLIP, Vision Transformer (ViT), Megatron-Turing NLG, DALL-E, Imagen, GauGAN2, VQGAN+CLIP, or the like. In some implementations, the system may select a text-to-image model based on factors such as open source, photorealistic, creative control, computational requirements, case of use, licensing, and the like. The less sophisticated a text-to-image model, the more meta prompting and/or additional tools/models are required to provide the same quality image outputs. In one embodiment, the first and second generative models are embodied in one large multimodal model (LMM), such as Imagen, CLIP, or the like.

In one embodiment, the generated visual content items are saved in a visual content library 142 as a new style image for users to select to generate new visual content items with new topic(s). Other implementations may utilize other models or other generative models to generate an image output with desired style(s) and topic(s) based on considerations of open source, photorealistic, creative control, computational requirements, case of use, licensing, and the like. The generative model(s) 126 may be included as part of the application services platform 110 or they may be external models that are called by the application services platform 110. In implementations where other models in addition to the generative model(s) 126 are utilized, those models may be included as part of the application services platform 110 or they may be external models that are called by the application services platform 110.

The request processing unit 122 also coordinates communication and exchange of data among components of the application services platform 110 as discussed in the examples which follow. The request processing unit 122 receives a user request to generate an image output with desired style(s) and topic(s) from the native application 114 or the browser application 112.

The prompt construction unit 124 may reformat or otherwise standardize any information to be included in the prompt to a standardized format that is recognized by the generative model(s) 126. The generative model(s) 126 is trained using training data in this standardized format, in some implementations, and utilizing this format for the prompts provided to the generative model(s) 126 may improve the output quality provided by the generative model(s) 126.

In some implementations, when the user data (e.g., user activity data 128a, preferences, etc.) from the user database 128 is already in the format directly processible by the generative model(s) 126, the prompt construction unit 124 does not need to convert the user data. In other implementations, when the user data is not in the format directly processible by the generative model(s) 126, the prompt construction unit 124 converts the user data to the format directly processible by the generative model(s) 126. Some common standardized formats recognized by a language model include plain text, HTML, JSON, XML, and the like. In one embodiment, the system converts user data into JSON, which is a lightweight and efficient data-interchange format.

Some common formats recognized by a LMM include JPEG (Joint Photographic Experts Group), PNG (Portable Network Graphics, TIFF (Tagged Image File Format), BMP (Bitmap Image File), GIF (Graphics Interchange Format), PSD (Photoshop Document), RAW, SVG (Scalable Vector Graphics), WEBP, OpenEXR, or the like.

The application services platform 110 complies with privacy guidelines and regulations that apply to the usage of the user data included in the user database 128 to ensure that users have control over how the application services platform 110 utilizes their data.

In one embodiment, metadata can be generated for the image output 154 to facilitate later retrieval based on a user query. For example, the metadata might detail that image output 154 is related to a birthday cake and a modern living room style. Consequently, any user query related to a birthday cake can be matched to the image output 154 using the metadata.

Given an existing style images and a user content request, the system can accurately vary the topic and/or style of the image output 154. With these features, the system unlocks the possibility for expanding image outputs in a style with complex details matching user desired topic(s).

In some implementations, the user may submit further requests for additional image output(s) to be generated and/or to further refine the image output(s) that has already been generated. The request processing unit 122 can store the topic and/or the style element data included in the image output(s) for the duration of a user session in which the user uses the native application 114 or the browser application 112. A technical benefit of this approach is that the style element data do not need to be retrieved each time that the user submits a prompt to generate image output(s). The request processing unit 122 maintains user session information in a persistent memory of the application services platform 110 and retrieves the style element data from the user session information in response to each subsequent prompt submitted by the user. The request processing unit 122 then provides the newly received user prompt(s) and the style element data to the prompt construction unit 124 or the first generative model 126a to construct the integrated textual prompt as discussed in the preceding examples.

All the above-discussed visual content library 142 (storing e.g., topics, styles, elements, or the like), request, prompts and responses 144, extracted/inferred user data 146 (e.g., user activities, preferences, or the like), and other asset data 148 can be stored in the enterprise data storage 140. The extracted/inferred user data 146 (e.g., activities, preferences, or the like) is tentatively linked with a user ID during a user session and saved in a cache. After the user session, extracted/inferred user data 146 is de-linked form the user ID as metadata of the resulted new style image(s) and saved in the visual content library 142. In addition, the extracted/inferred user data 146 linked with the user ID is saved back to the user database 128.

The enterprise data storage 140 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCl), network virtualization and software-defined networking (SDN), container storage, and the like.

FIGS. 2A-2I are diagrams of an example user interface of an AI-based visual style transfer application that implements the techniques described herein. The example user interface shown in FIGS. 2A-2I is a user interface of an AI-based visual style transfer application within an AI-based design platform, such as but not limited to Microsoft Designer®. However, the techniques herein for AI-based visual style transfer via automatically describing a visual content item in a text prompt are not limited to use in an AI-based design platform and may be used to generate visual content for other types of applications including but not limited to presentation applications, website authoring applications, collaboration platforms, communications platforms, and/or other types of applications in which users create, view, and/or modify various types of visual content. Such applications can be a mini application in an AI-based design application, a stand-alone application, or a plug-in of any application on the client device 105, such as the browser application 112, the native application 114, and the like. For example, the system can work on the web or within a virtual meeting and collaboration application (e.g., Microsoft Teams®) or an email application (e.g., Outlook®). The system can be integrated into the Microsoft Viva® platform or could work within a browser (e.g., Windows® Edge®). The system can also work within a social media website/application (e.g., Facebook®, Instagram®).

FIG. 2A shows an example of the user interface 205 of an AI-based visual style transfer application in which the user is interacting with AI generative model(s) to generate an image output with desired style(s) and topic(s). The user interface 205 includes a control pane 215, a chat pane 225 and a scrollbar 235. The user interface 205 may be implemented by the native application 114 and/or the browser application 112.

In some implementations, the control pane 215 includes an Assistant button 215a, a Generate button 215b, a Share button 215c, and a search field 215d. The AI-Assistant button 215a can be selected to provide visual style transfer assistant functions as later discussed. In some implementations, the chat pane 225 provides a workspace in which the user can enter prompts in the AI-based visual style transfer application for generating image output(s) with desired style(s) and topic(s). In the example shown in FIG. 2A, the chat pane 225 shows at least two mini application tiles 225a and 225b.

The mini application tile 225a represents an image creator and depicts a description of “Create any image—just decide a style image and a content image/text.” The mini application tile 225a also depicts a prompt enter box over a background image and a “Generate’ button. The prompt enter box shows an instruction of “Select or drop a style image and a content image/text.”

The mini application tile 225b represents a design creator and depicts a description of “Create any graphic design—just decide a style image and a content image/text.” The mini application tile 225b also depicts a prompt enter box over a background image and a “Generate’ button. The prompt enter box shows an instruction of “Select or drop one graphic design style image and a content image/text.”

Rather than a natural language prompt, the mini application tiles 225a, 225b invite a user to select or drop a style image and a content image/text that the user would like to have automatically generated by the generative model(s) 126 of the application services platform 110. The application submits the style image prompt and user information identifying the user of the application to the application services platform 110. The application services platform 110 processes the request according to the techniques provided herein to generate an image output with desired style(s) and topic(s).

The Generate button 215b can be selected to generate an image output with desired style(s) and topic(s) corresponding to a user style request (e.g., the modern living room image 150a) and a user content request (e.g., the birthday cake image 152b). The Share button 215c can be selected to trigger a dropdown list of applications to share an image output (e.g., the image output 154). For example, the user can post the image output on a social media application (e.g., Facebook®) to celebrate a contact's birthday. The search field 215d is for a user to enter a search word, phrase, paragraph, and the like within the visual content library 142, the requests, prompts, and responses 144, the extracted/inferred user data 146 (e.g., activities, preferences, or the like), the other asset data 148, and the like. The fields in the visual style transfer application can provide auto-fill and/or spell-check functions.

FIG. 2B continues from FIG. 2A upon a selection of the mini application tile 225a. In this example, the chat pane 225 shows a prompt enter box 225c with an instruction of “Select or drop a style image and a content image/text” and several style images for the user to select. After the user drops the modern living room image 150a and the birthday cake image 152b into the prompt enter box 225c, the chat pane 225 shows a prompt enter box 225d with an instruction of “Select one of the following images or generate other images of the same style” and several image outputs generated by the generative model(s) 126 for the user in FIG. 2C. The chat pane 225 further shows a field 225e with an instruction of “Explore other styles” and a field 225f with an instruction of “Explore other topics.”

FIG. 2D continues from FIG. 2C upon a selection of another style image (e.g., a breakfast shop with a milk cardboard box design) in the field 225e while maintaining the same birthday cake topic. In this example, the chat pane 225 shows the prompt enter box 225d with an instruction of “Display style image and output image side-by-side” and the respective style image and output image underneath.

FIG. 2E also continues from FIG. 2C upon a selection of another style image (e.g., a digital camera with a transparent case) in the field 225e while maintaining the same birthday cake topic. In this example, the chat pane 225 shows the prompt enter box 225d with the same instruction of “Display style image and output image side-by-side” and the respective style image and output image underneath.

FIG. 2F further continues from FIG. 2C upon a selection of another style image (e.g., a shopping area) in the field 225e while maintaining the same birthday cake topic. In this example, the chat pane 225 shows the prompt enter box 225d with the same instruction of “Display style image and output image side-by-side” and the respective style image and output image underneath.

FIG. 2G further continues from FIG. 2C upon a selection of another style image (e.g., a beach in a coconut) in the field 225e and a selection of another topic (e.g., pandas) in the field 225f. In this example, the chat pane 225 shows the prompt enter box 225d with the same instruction of “Display style image and output image side-by-side” and the respective style image and output image underneath.

FIG. 2H continues from FIG. 2A upon a selection of the mini application tile 225b. In this example, the chat pane 225 shows a prompt enter box 225g with an instruction of “Select or drop one graphic design style image and a content image/text” and several graphic design style images for the user to select. After the user drops a thanksgiving greeting card image and the birthday cake image 152b into the prompt enter box 225g, the chat pane 225 shows a prompt enter box 225h with an instruction of “Display style image and output image side-by-side” and the respective style image and output image underneath in FIG. 2I.

In some implementations, the system provides a feedback loop by augmenting thumbs up and thumbs down buttons for each visual content output in the user interface 205. If the user dislikes a visual content output, the system can ask why and use the user feedback data to improve the generative model(s) 126. A thumbs down click could also prompt the user to indicate whether the visual content output was too bright, too dark, too big, too small, or was assigned the wrong style/topic, or the like.

FIG. 3 is a diagram showing additional features of the prompt construction unit 124 of the application services platform shown in FIG. 1A. The prompt construction unit 124 formats and submits the prompt for the generative model(s) 126. The prompt construction unit 124 includes a prompt formatting unit 302 and a prompt submission unit 304.

The prompt formatting unit 302 receives a textual style prompt from the first generative model 126a, and a user textual topic prompt (e.g., the birthday cake text 152a in FIG. 1B) to generate an integrated textual prompt for the second generative model 126b to generate an image output with desired style(s)/topic(s) (e.g., the modern living room styled birthday cake image 154a in FIG. 1B). The prompt formatting unit 302 formats the meta prompt according to a prompt template and includes the style image prompt and the topic prompt in the integrated textual prompt. The integrated textual prompt (e.g., the meta prompt in Table 2) can include instructions that guide the second generative model 126b to generate an image output with desired style(s) and topic(s). The system can instruct the generative model(s) 126 to generate a single-shot prompt (i.e., including a single example or instruction to guide the language model's response) or a multi-shot prompt (i.e., including multiple examples or instructions to give the model more context and improve its understanding of the task) for generating the virtual content output.

As mentioned, the prompt construction unit 124 can convert the user data (e.g., user activity data 128a, preferences, etc.) to a format directly processible by the first generative model 126a. As such, the user data, e.g., the user activity data 128a, can be included in an image output, such as the birthday party invitation card as discussed. Other implementations may include instructions in addition to and/or instead of one or more of these instructions. Furthermore, the specific format of the prompt may differ in other implementations.

In some implementations, the application services platform 110 includes moderation services that analyze user prompt(s), content generated by the generative model(s) 126, and/or the user data obtained from the user database 128, to ensure that potentially objectionable or offensive content is not generated or utilized by the application services platform 110.

If potentially objectionable or offensive content is detected in the user data obtained from the user database 128, the moderation services provides a blocked content notification to the client device 105 indicating that the prompt(s), the user data is blocked from forming the meta prompt. In some implementations, the request processing unit 122 discards any user data that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the generative model(s) 126 as an input.

In one embodiment, the prompt submission unit 304 submits the user prompt(s), and/or the meta prompt to the moderation services to ensure that the prompt does not include any potentially objectionable or offensive content. The prompt formatting unit 302 halts the processing of the user prompt(s), and/or the meta prompt in response to the moderation services determining that the user prompt(s) and/or the visual content data includes potentially objectionable or offensive content. The image processing unit 130 may include an OCR tool to identify and remove text element(s) from a style image. In some implementations, the OCR tool store the text element(s) in editable characters for potential use. The image processing unit 130 can access the user database 128 for user input image data for pre-processing, such as identifying and removing textual elements. With the original text removed, the system can regenerate new text based on the user prompt, without the typographical errors and/or objectionable content, then provide the visual content output to the client device 105.

The user database 128 can be implemented on the application services platform 110 in some implementations. In other implementations, at least a portion of the user database 128 are implemented on an external server that is accessible by the prompt construction unit 124.

As mentioned, the application services platform 110 complies with privacy guidelines and regulations that apply to the usage of the user data included in the user database 128 to ensure that users have control over how the application services platform 110 utilizes their data. The user is provided with an opportunity to opt into the application services platform 110 to allow the application services platform 110 to access the user data and enable the generative model(s) 126 to generate visual content according to the user's desired style/topic. In some implementations, the first time that an application, such as the native application 114 or the browser application 112 presents an AI assistant to the user, the user is presented with a message that indicates that the user may opt into allowing the application services platform 110 to access user data included in the user database 128 to support the visual style transfer functionality. The user may opt into allowing the application services platform 110 to access all or a subset of user data included in the user database 128. Furthermore, the user may modify their opt-in status at any time by accessing their user data and selectively opting into or opting out of allowing the application services platform 110 from accessing and utilizing user data from the user database 128 as a whole or individually.

Referring back to the moderation services, the moderation services generates a blocked content notification in response to determining that the user prompt(s), and/or the meta prompt includes potentially objectionable or offensive content, and the notification is provided to the native application 114 or the browser application 112 so that the notification can be presented to the user on the client device 105. For instance, the user may attempt to revise and resubmit the user prompt(s). As another example, the system may generate another meta prompt after removing task data associated with the potentially objectionable or offensive content.

The prompt submission unit 304 submits the integrated text prompt to the second generative model 126b. The second generative model 126b analyzes the integrated text prompt and generates visual content output(s) based on the integrated text prompt. The prompt submission unit 304 submits the visual content output(s) generated by the second generative model 126b to the moderation services to ensure that the image output(s) does not include any potentially objectionable or offensive content. The prompt formatting unit 302 can halt the processing of the visual content output(s) in response to the moderation services determining that the graphic design includes potentially objectionable or offensive content. The moderation services generates a blocked content notification in response to determining that the visual content output(s) includes potentially objectionable or offensive content, and the notification is provided to the prompt formatting unit 302. The prompt formatting unit 302 may attempt to revise and resubmit the integrated text prompt. If the moderation services does not identify any issues with the visual content output(s), the prompt submission unit 304 provides the visual content output(s) to the request processing unit 122. The request processing unit 122 provides the visual content output(s) to the native application 114 or the browser application 112 depending upon which application was the source of the visual content request.

The moderation services performs several types of checks on the natural language prompt input by the user, the user data obtained from the user database 128, the visual content output(s) generated by the generative model(s) 126, and/or the visual content output(s) being accessed or modified by the user in the native application 114 or the browser application 112. The moderation services can be implemented by a machine learning model trained to analyze the content of these various inputs and/or outputs to perform a semantic analysis on the content to predict whether the content includes potentially objectionable or offensive content. The moderation services can perform another check on the content using a machine learning model configured to analyze the words and/or phrase used in content to identify potentially offensive language/image/sound. The moderation services can compare the language used in the content with a list of prohibited terms/images/sounds including known offensive words and/or phrases, images, sounds, and the like. The moderation services can provide a dynamic list that can be quickly updated by administrators to add additional prohibited terms/images/sounds. The dynamic list may be updated to address problems such as words or phrases becoming offensive that were not previously deemed to be offensive. The words and/or phrases added to the dynamic list may be periodically migrated to the guard list as the guard list is updated. The specific checks performed by the moderation services may vary from implementation to implementation. If one or more of these checks determines that the textual/visual content includes offensive content, the moderation services can notify the application services platform 110 that some action should be taken.

In some implementations, the moderation services generates a blocked content notification, which is provided to the client device 105. The native application 114 or the browser application 112 receives the notification and presents a message on a user interface of the application that the user prompt received by the request processing unit 122 could not be processed. The user interface provides information indicating why the blocked content notification was issued in some implementations. The user may attempt to refine a natural language prompt to remove the potentially offensive content. A technical benefit of this approach is that the moderation services provides safeguards against both user-created and model-created content to ensure that prohibited offensive or potentially offensive content is not presented to the user in the native application 114 or the browser application 112.

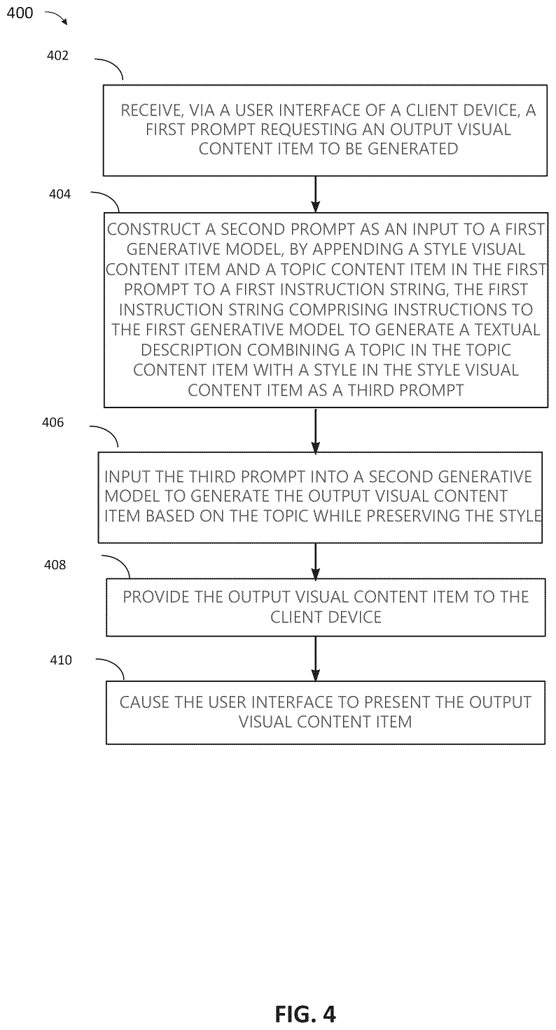

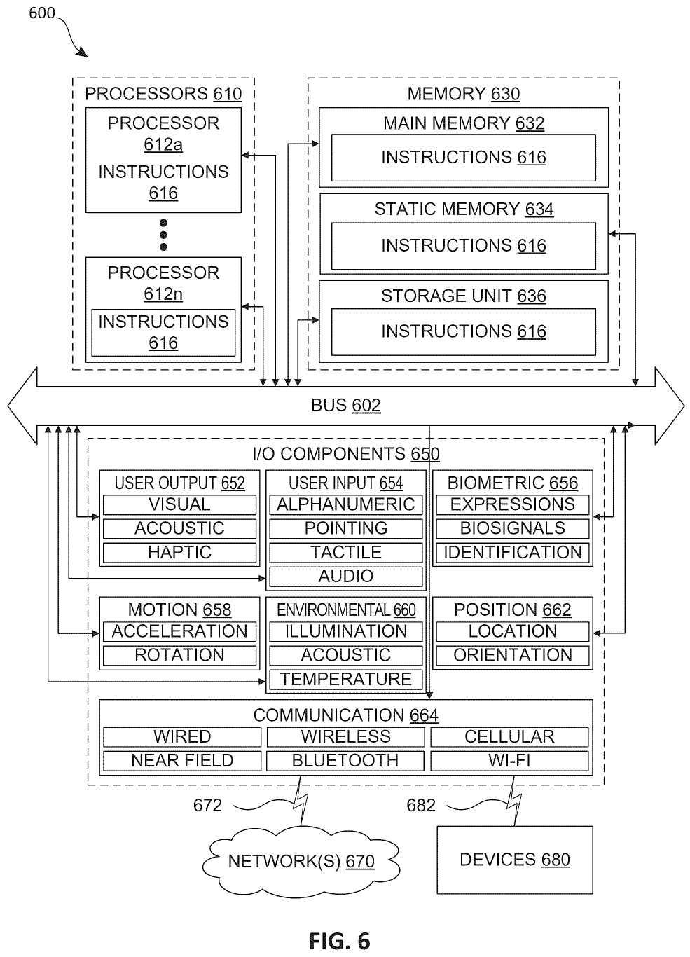

FIG. 4 is a flow chart of an example process 400 for AI-based visual style transfer via automatically describing a visual content item in a text prompt according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one embodiment, for example, in step 402, the request processing unit 122 receives, via a user interface (e.g., the user interface 205) of a client device (e.g., the client device 105), a first prompt (e.g., including content items selected or dropped in the prompt enter box 225c in FIG. 2B) requesting an output visual content item to be generated, the first prompt including a style visual content item (e.g., the modern living room image 150a in FIG. 2B) and a topic content item (e.g., the birthday cake image 152b in FIG. 2B).

In one embodiment, in step 404, the prompt construction unit 124 constructs a second prompt as an input to a first generative model (e.g., the first generative model 126a), by appending the style visual content item and the topic content item to a first instruction string (e.g., including the meta prompt in Table 1), the first instruction string comprising instructions to the first generative model to generate a textual description combining a topic (e.g., a birthday cake) in the topic content item with a style (e.g., a modern living room style) in the style visual content item as a third prompt (e.g., the meta prompt in Table 2).

In one embodiment, in step 406, the prompt construction unit 124 inputs the third prompt into a second generative model e.g., the second generative model 126b) to generate the output visual content item (e.g., the modern living room styled birthday cake image 154a) by including the topic in the output visual content item and replacing one or more visual elements of the style visual content item based on the topic while preserving the style.

In some implementations, the topic content item comprises at least one of a visual content item (e.g., the birthday cake image 152b) or a textual content item (e.g., the birthday cake text 152a). For instance, the topic content item includes at least one object (e.g., a birthday cake). The first generative model is a language model or a multi-modal model, while the second generative model is a text-to-image model or a vision model.

In one embodiment, in step 408, the request processing unit 122 provides the output visual content item to the client device. For example, the output visual content item is a photo, a diagram, a chart, an image (e.g., the image outputs in FIGS. 2C-2G and 2I), an infographic, a video, an animation, a screenshot, a meme, a slide deck, a pictogram, an ideogram, or a software application background. In one embodiment, in step 410, the request processing unit 122 causes the user interface to present the output visual content item (e.g., the output visual content items in FIGS. 2C-2G and 2I).

In some implementations, the request processing unit 122 receives at least one user feedback on the output visual content item (e.g., the image outputs in FIG. 2C) via the user interface (e.g., the user interface 205). For example, the user feedback is collected via a use selection of at least one of a thumbs-up tab, a thumbs-down tab, a neutral tab, or a generating-more-image tab, a textual input, or a combination thereof. The prompt construction unit 124 can construct a fourth prompt by appending the feedback and the output visual content item to another instruction string, the other instruction string comprising instructions to the first generative model (e.g., the first generative model 126a) to generate another textual description combining the feedback (e.g., a thumb-down tab) and the output visual content item as a fifth prompt, and to input the fifth prompt into the second generative model (e.g., the second generative model 126b) to generate a subsequent output visual content item by replacing one or more visual elements of the output visual content item based on the feedback while preserving the topic and the style. The request processing unit 122 then provides the subsequent output visual content item to the client device (e.g., the client device 105), and causes the user interface (e.g., the user interface 205) to present the subsequent output visual content item.

In other implementations, the instructions to the first generative model (e.g., the first generative model 126a) further comprise instructions to check whether the third prompt (e.g., the meta prompt in Table 2) contains the topic (e.g., a birthday cake) and the style (e.g., a modern living room style), and to input the third prompt into the second generative model (e.g., the second generative model 126b) when the third prompt contains the topic and the style. In one embodiment, the instructions to the first generative model further comprise instructions to construct a sixth prompt as an input to the first generative model (e.g., the first generative model 126a), by appending the missed at least one of the topic or the style and the third prompt (e.g., the meta prompt in Table 2) to another instruction string, the other instruction string comprising instructions to the first generative model to generate another textual description combining the missed at least one of the topic or the style and the third prompt as a seventh prompt, and to input the seven prompt into the second generative model (e.g., the second generative model 126b) to generate a subsequent output visual content item by replacing one or more visual elements of the style visual content item based on the topic while preserving the style. The request processing unit 122 then provides the subsequent output visual content item to the client device (e.g., the client device 105), and causes the user interface (e.g., the user interface 205) to present the subsequent output visual content item.

The system allows users to upload images as style prompts thus simplifying the creative process for the users. This case of use increases user productivity and utilization, as well as attracts more non-technical users. By automating the style transfer process, the system eliminates reliance on user-manually-generated style prompts. This solution significantly lowers the barrier to create high-quality, stylized images, and makes the design process more accessible and less intimidating for users. The system can apply the style transfer to a range of visual content types, including images, images with text, or the like, which can be instrumental in tasks like design template creation, thereby enhancing the versatility of a design platform.

In another embodiment, the request processing unit 122 or the prompt construction unit 124 performs content moderation on the image output(s) before providing the image output(s) to the client device (e.g., the client device 105). After the content moderation, the request processing unit 122 or the prompt construction unit 124 adds the image output(s) as an additional style image(s) in a visual content library (e.g., the visual content library 142). In addition, the request processing unit 122 or the prompt construction unit 124 adds metadata associated with the image output(s) in the visual content library, the metadata comprises at least one of the topic (e.g., the birthday cake), the style (e.g., the modern living room style), the visual element(s) of the style after replacing, the text added in the style image (e.g., “happy birthday in FIG. 2I), and the like.

In some implementations, the system can share the visual content output(s) immediately, so that the user can celebrate the relevant event (e.g., a birthday). In other implementations, the system can start a new AI chat to help the user to plan the events by suggesting an action plan with steps. For example, when the user organizes a birthday party, this would often involve setting a budget, creating a guest list, planning the food and drinks, arranging entertainment, reserving and then decorating the venue, and the like. In other implementations, the system can perform the actions of the event on behalf of the user, such as setting the budget for the birthday party, reserving the venue, and the like.

Therefore, the system provides visual content style transfer to match with user selected style(s) and topic(s), without manually crafting detailed language prompts. The system fetches one or more style images and vary their visual elements based on the topic(s) to personalize the style image(s) for the user. In addition, the system can modify the image output(s) by applying other style image(s) and/or topic(s).

There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

In an example, the application services platform 110 can store enterprise data separately from generative model training data, to reduce the risk of unintentionally leaking sensitive information during model generation. The application services platform 110 can limit access to generative models and the enterprise data. The application services platform 110 can also implement proper access controls, strong authentication, and authorization mechanisms to ensure that only authorized personnel can interact with the selected model and the enterprise data.

The application services platform 110 can also run the generative model(s) 126 in a secure computing environment. Moreover, the application services platform 110 can employ robust network security, firewalls, and intrusion detection systems to protect against external threats. The application services platform 110 can encrypt the enterprise data and any data in transit. The application services platform 110 can also employ encryption standards for data storage and data transmission to safeguard against data breaches.

Moreover, the application services platform 110 can implement strong security measures around the generative model(s) 126 itself, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data (especially user data) is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of enterprise data and the responsible use of generative models. In addition, the application services platform 110 can stay up-to-date with evolving security threats and best practices that are essential for ongoing data protection.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

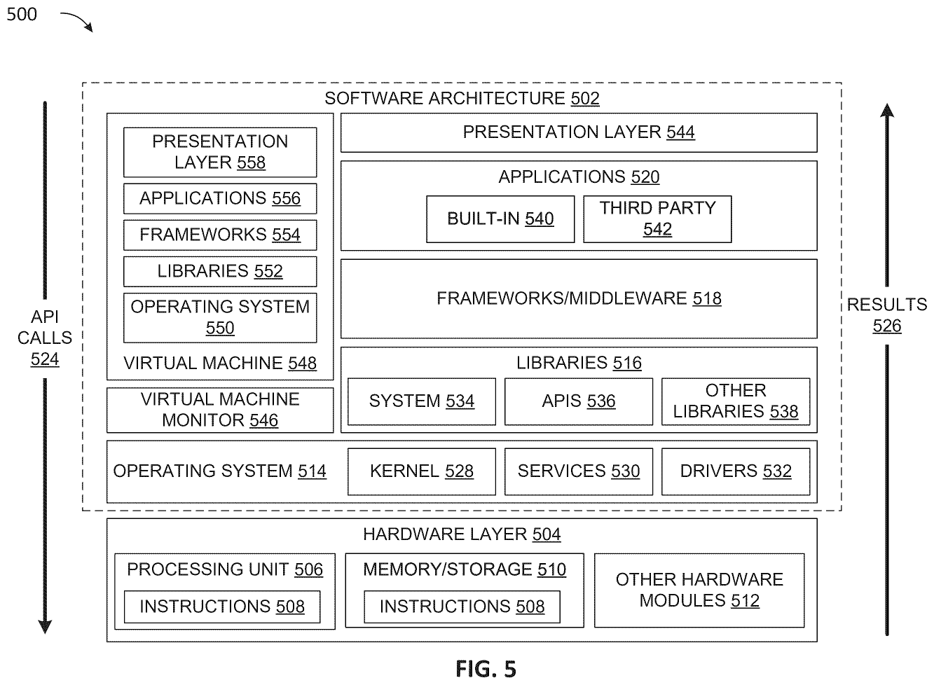

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform the following operations:
receiving, via a user interface of a client device, a first prompt requesting an output visual content item to be generated, the first prompt including a style visual content item and a topic content item;
constructing a second prompt by a prompt construction unit as an input to a first generative model, by appending the style visual content item and the topic content item to a first instruction string, the first instruction string comprising instructions to the first generative model to generate a textual description combining a topic in the topic content item with a style in the style visual content item as a third prompt;
inputting the third prompt into a second generative model to generate the output visual content item by including the topic in the output visual content item and replacing one or more visual elements of the style visual content item based on the topic while preserving a style of the style visual content item;
providing the output visual content item to the client device; and
causing the user interface to present the output visual content item.

2. The data processing system of claim 1, wherein the machine-readable storage medium further includes instructions configured to cause the processor alone or in combination with other processors to perform operations of:
receiving at least one user feedback on the output visual content item via the user interface.

3. The data processing system of claim 2, wherein the instructions to the first generative model further comprise instructions to construct a fourth prompt as an input to the first generative model, by appending the feedback and the output visual content item to another instruction string, the other instruction string comprising instructions to the first generative model to generate another textual description combining the feedback and the output visual content item as a fifth prompt, and to input the fifth prompt into the second generative model to generate a subsequent output visual content item by replacing one or more visual elements of the output visual content item based on the feedback while preserving the topic and the style of the style visual content item.

4. The data processing system of claim 3, wherein the machine-readable storage medium further includes instructions configured to cause the processor alone or in combination with other processors to perform operations of:
providing the subsequent output visual content item to the client device; and
causing the user interface to present the subsequent output visual content item.

5. The data processing system of claim 2, wherein the user feedback is collected via a user selection of at least one of a thumbs-up tab, a thumbs-down tab, a neutral tab, or a generating-more-image tab, a textual input, or a combination thereof.

6. The data processing system of claim 1, wherein the instructions to the first generative model further comprise instructions to check whether the third prompt contains the topic and the style, and to input the third prompt into the second generative model when the third prompt contains the topic and the style.

7. The data processing system of claim 6, wherein the instructions to the first generative model further comprise instructions to construct a sixth prompt as an input to the first generative model when the third prompt misses at least one of the topic or the style, by appending the missed at least one of the topic or the style and the third prompt to another instruction string, the other instruction string comprising instructions to the first generative model to generate another textual description combining the missed at least one of the topic or the style and the third prompt as a seventh prompt, and to input the seventh prompt into the second generative model to generate a subsequent output visual content item by replacing one or more visual elements of the style visual content item based on the topic while preserving the style.

8. The data processing system of claim 7, wherein the machine-readable storage medium further includes instructions configured to cause the processor alone or in combination with other processors to perform operations of:
providing the subsequent output visual content item to the client device; and
causing the user interface to present the subsequent output visual content item.

9. The data processing system of claim 1, wherein the output visual content item is a photo, a diagram, a chart, an image, an infographic, a video, an animation, a screenshot, a meme, a slide deck, a pictogram, an ideogram, or a software application background.

10. The data processing system of claim 1, wherein the topic content item comprises at least one of a visual content item or a textual content item.

11. The data processing system of claim 1, wherein the first generative model is a language model or a multi-modal model.

12. The data processing system of claim 1, wherein the second generative model is a text-to-image model or a vision model.

13. A method comprising:
receiving, via a user interface of a client device, a first prompt requesting an output visual content item to be generated, the first prompt including a style visual content item and a topic content item;
constructing a second prompt by a prompt construction unit as an input to a first generative model, by appending the style visual content item and the topic content item to a first instruction string, the first instruction string comprising instructions to the first generative model to generate a textual description combining a topic in the topic content item with a style in the style visual content item as a third prompt;
inputting the third prompt into a second generative model to generate the output visual content item by including the topic in the output visual content item and replacing one or more visual elements of the style visual content item based on the topic while preserving the style;
providing the output visual content item to the client device; and
causing the user interface to present the output visual content item.

14. The method of claim 13, further comprising;
receiving at least one user feedback on the output visual content item via the user interface.

15. The method of claim 14, wherein the instructions to the first generative model further comprise instructions to construct a fourth prompt as an input to the first generative model, by appending the feedback and the output visual content item to another instruction string, the other instruction string comprising instructions to the first generative model to generate another textual description combining the feedback and the output visual content item as a fifth prompt, and to input the fifth prompt into the second generative model to generate a subsequent output visual content item by replacing one or more visual elements of the output visual content item based on the feedback while preserving the topic and the style.

16. The method of claim 15, further comprising;
providing the subsequent output visual content item to the client device; and
causing the user interface to present the subsequent output visual content item.

17. A non-transitory computer readable medium on which are stored instructions that, when executed, cause a programmable device to perform functions of:
receiving, via a user interface of a client device, a first prompt requesting an output visual content item to be generated, the first prompt including a style visual content item and a topic content item;
constructing a second prompt by a prompt construction unit as an input to a first generative model, by appending the style visual content item and the topic content item to a first instruction string, the first instruction string comprising instructions to the first generative model to generate a textual description combining a topic in the topic content item with a style in the style visual content item as a third prompt;
inputting the third prompt into a second generative model to generate the output visual content item by including the topic in the output visual content item and replacing one or more visual elements of the style visual content item based on the topic while preserving the style;
providing the output visual content item to the client device; and
causing the user interface to present the output visual content item.

18. The non-transitory computer readable medium of claim 17, wherein the instructions when executed, further cause the programmable device to perform functions of:
receiving at least one user feedback on the output visual content item via the user interface.

19. The non-transitory computer readable medium of claim 18, wherein the instructions to the first generative model further comprise instructions to construct a fourth prompt as an input to the first generative model, by appending the feedback and the output visual content item to another instruction string, the other instruction string comprising instructions to the first generative model to generate another textual description combining the feedback and the output visual content item as a fifth prompt, and to input the fifth prompt into the second generative model to generate a subsequent output visual content item by replacing one or more visual elements of the output visual content item based on the feedback while preserving the topic and the style.

20. The non-transitory computer readable medium of claim 19, wherein the instructions when executed, further cause the programmable device to perform functions of:
providing the subsequent output visual content item to the client device; and
causing the user interface to present the subsequent output visual content item.
